(19) United States
(12) Patent Application Publication
(10) Pub. No.: US 2023/0064538 A1
(43) Pub. Date: Mar. 2, 2023

(54) FOOD ORDER SERVICE SYSTEM

(71) Applicant: Young Woo LEE, Seoul (KR)

(72) Inventor: Young Woo LEE, Seoul (KR)

(21) Appl. No.: 17/759,262

(22) PCT Filed: May 12, 2020
(86) PCT No.: PCT/KR2020/006218

§ 371 Date: Jul. 21, 2022

(30) Foreign Application Priority Data
Mar. 2, 2020 (KR) 10-2020-0026016

(51) Int. Cl. G06Q 30/06

(52) U.S. Cl. CPC G06Q 30/0621; G06Q 30/0641; G06Q 30/0633; G06Q 50/12

(57) ABSTRACT

The present invention relates to a food order service system, and objects of the present invention is to provide a food order service system in which a consumer can order and pay for a small amount of cooked or processed food easily and quickly, thereby allowing people to save a cooking time, and food expense caused by leftovers can be reduced. An embodiment of the present invention discloses a food order service system comprising: an operation server unit storing various types of food menu information and ingredient information for each of the food menu information, generating order information selected by an orderer based on the food menu information, transmitting the order information to a seller, and processing a payment for the order information; a seller service execution unit installed in a seller communication terminal, registering the food menu information and the ingredient information in the operation server unit, and receiving the order information from the operation server unit; and an orderer service execution unit installed in an orderer communication terminal, receiving the food menu information and the ingredient information from the operation server unit, classifying the food menu information by category, providing the classified food menu information to the orderer so that the orderer selects food menu in each category, generating the order information based on selected food menu information, and transmitting the order information to the operation server unit.

### FIELD OF THE INVENTION

The present invention relates to a food order service system.

### BACKGROUND OF THE INVENTION

As modern people are busy, the lifestyles are changing, and the opportunity cost of time is increasing. Accordingly, this phenomenon generates new consumer needs for distribution services.

In fact, delivery orders are on the rise for several reasons, such as an increase in the proportion of single-person households, single parent mothers taking care of both childcare and housework, and dual income couples, and an increase in the number of people seeking comfortable lives due to the economic contraction and artificial intelligence. In fact, the food delivery business for food and groceries is increasing at an annual rate of 200% due to the burden of eating out.

In addition, there are many burdens and inconveniences in processes of preparing, cooking, and processing food, such as food expenses on which a household with two or more people spends about 7 million won a year, cooking time, concerns about menu at every meal, the burden of purchasing a lot of ingredients for a small amount of cooking and disposing of leftovers. Meanwhile, in the case of food delivery, there is a problem that disposable packaging ingredients generated during the food delivery process cause wastes of resources and adversely affect the environment.

In order to reduce these inconveniences and burdens, more and more consumers want to receive various food, including fresh food such as farm raised vegetables and freshly cooked hot food as well as food with expiration dates sold in online and offline supermarkets, to be delivered at their desired time and place.

However, in the case of food through these delivery service, since consumers have to purchase more than a single dish, there are also high cost in food expenses and hassles when regularly purchasing a small amount of food.

### DETAILED DESCRITION OF THE INVENTION

### Technical Problems

An embodiment of the present invention provides a food order service system in which a consumer can order and pay for a small amount of cooked or processed food, such as one serving, easily and quickly, office workers or people who eat alone can save time, and costs and resources caused by excessively purchased ingredients and leftovers can be reduced.

### SUMMARY OF THE INVENTION

A food order service system according to one embodiment of the present invention, comprises: an operation server unit storing various types of food menu information and ingredient information for each of the food menu information, generating order information selected by an orderer based on the food menu information, transmitting the order information to a seller, and processing a payment for the order information; a seller service execution unit installed in a seller communication terminal, registering the food menu information and the ingredient information in the operation server unit, and receiving the order information from the operation server unit; and an orderer service execution unit installed in an orderer communication terminal, receiving the food menu information and the ingredient information from the operation server unit, classifying the food menu information by category, providing the classified food menu information to the orderer so that the orderer selects food menu in each category, generating the order information based on selected food menu information, and transmitting the order information to the operation server unit.

The food menu information may include food menu information with respect to at least one food category of side dish, fruit, vegetable, meat, fish, aqua cultured food, nut, snack, seasoning, grain, soy sauce, salted fish, and soup.

the orderer service execution unit may comprise: a food menu information display selection unit displaying the food menu information for each food menu as a food icon selectable by the orderer; a food ingredient information display unit displaying ingredient information with respect to the food menu information selected through the food menu information display selection unit; a payment request unit calculating and displaying a payment amount for the food menu information selected through the food menu information display selection unit and requesting a payment for the corresponding payment amount to the operation server unit according to a selection of the orderer; and an order request unit generating order information for the food menu information selected through the food menu information display selection unit when the operation server unit completes the payment and transmitting the order information to the operation server unit.

Whenever the food icon is selected, the food menu information display selection unit may count up a quantity of the selected food menu and display the quantity of the food menu on the food icon, and when a selection of the food icon has been kept over a preset period of time, the previously selected food menu may be reset.

The orderer service execution unit may comprise: a favorite set menu setting unit generating a favorite set menu by moving at least one of the food icon provided through the food menu information display selection unit to a favorite area; and a favorite set menu selection unit receiving a selection in a unit of the favorite set menu and transmitting the food menu information included in the selected favorite set menu to a payment request unit.

The orderer service execution unit may further include: a payment amount charging unit charged with a certain amount of money in balance of the orderer in conjunction with the operation server unit according to a selection of the orderer; and a balance based food ordering unit that is input a payable amount, or a price limit, within a range of the deposit, balance, or charged amount through the payment amount charging unit, wherein when the payable amount, or a price limit, is set, the balance based food ordering unit 380 generates a virtual menu block with a size corresponding to the set payable amount, or the set price limit, forms menu unit blocks for each food menu included in the food menu information selected through the food menu information display selection unit, respectively, and includes them into the virtual menu block. In this case, the sizes of the menu unit blocks are adjusted according to the orderer's operation, but the sum of the total sizes of the menu unit blocks is adjusted not to exceed the size of the virtual menu block. Accordingly, the quantity of food menu representing each menu unit block with an adjusted size can be adjusted within the price limit.

In addition, a minimum size limit of the menu unit block at which each size of the menu unit blocks may be reduced to the smallest, is a size indicating one food unit, that is, one food menu, and a maximum size limit of the menu unit block at which each size of the menu unit blocks, can increase to the largest, is a size obtained by subtracting the total sizes of minimum size limits of the other menu unit blocks included in the virtual menu block from the total size of the virtual menu block.

The food order service system may be operated by being applied in an offline store and an online store connected to the seller communication terminal and receiving an order from the orderer communication terminal.

### TECHNICAL EFFECTS OF THE INVENTION

The present invention provides a food order service system in which a consumer can order and pay for a small amount of cooked or processed food, such as one serving, easily and quickly, office workers or people who eat alone can save time, and costs and resources caused by excessively purchased ingredients and leftovers can be reduced.

Accordingly, the present invention can reduce food waste and wasted ingredients in the cooking process, can contribute to public health by supplying a broad variety of food at a low cost, and can also help household or individual economy by supplying food and ingredients for about thousands won.

### BRIEF DESCRIPTION OF THE DRAWINGS

FIG. 1 is a schematic diagram illustrating an overall configuration relationship of a food order service system according to an embodiment of the present invention.

FIG. 2 is a block diagram illustrating an overall configuration of a food order service system according to an embodiment of the present invention.

FIG. 3 is a block diagram illustrating a detailed configuration of an orderer service execution unit according to an embodiment of the present invention.

FIG. 4 is a drawing illustrating a food category selection screen of a food menu information display selection unit according to an embodiment of the present invention.

FIG. 5 is a drawing illustrating a food menu selection screen of the food menu information display selection unit according to an embodiment of the present invention.

FIGS. 6 and 7 are drawings for explaining a function of counting up and resetting the quantity of food menu purchases through the food menu information display selection unit in the food menu information display selection unit.

FIG. 8 is a drawing illustrating a method of creating a favorite set menu through a favorite set menu setting unit according to an embodiment of the present invention.

FIG. 9 is a drawing illustrating a method of creating a favorite set menu through a favorite set menu setting unit according to an embodiment of the present invention.

FIGS. 10 to 12 are drawings for explaining a method of selecting and setting the number of menus within a budget price through a balance based food ordering unit according to an embodiment of the present invention.

### BEST MODE FOR THE INVENTION

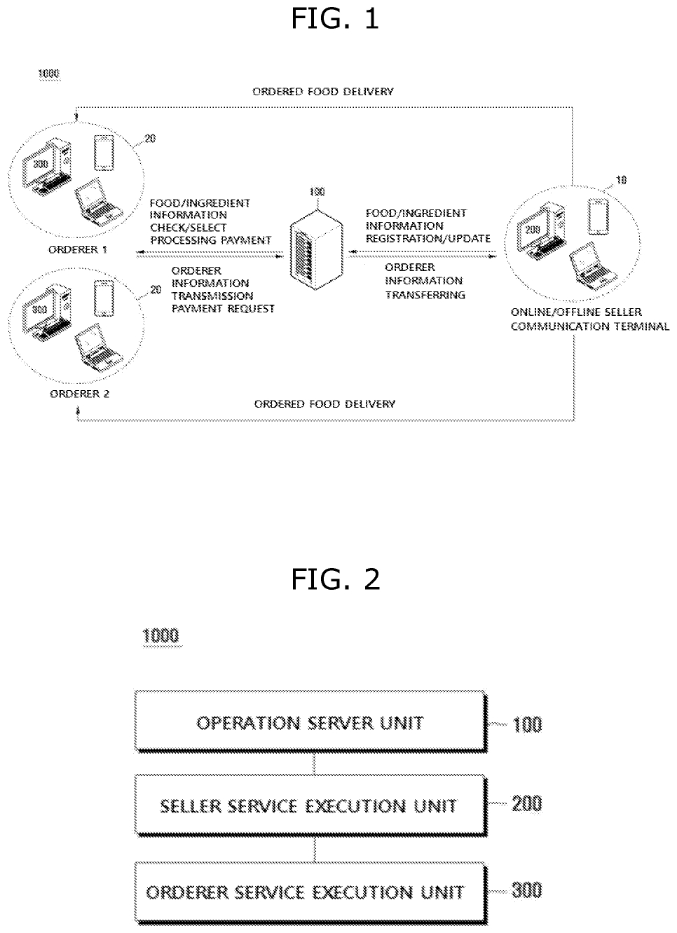

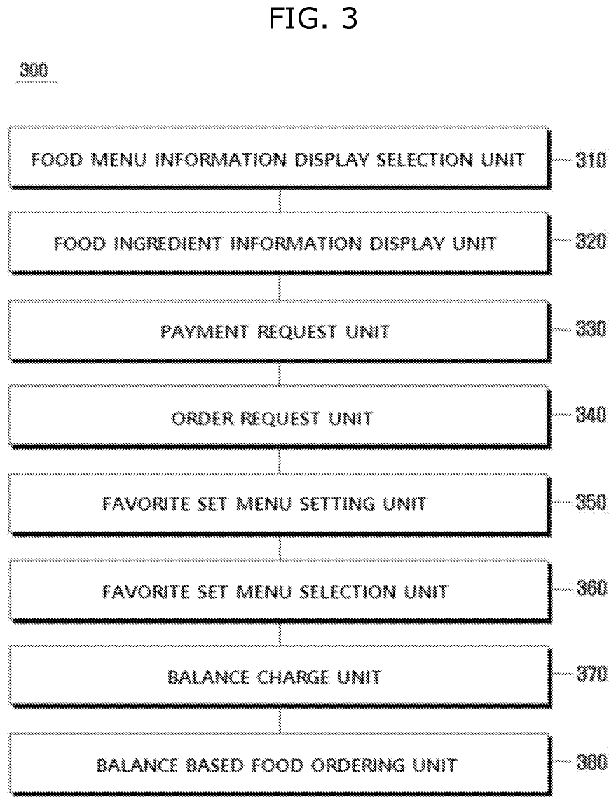

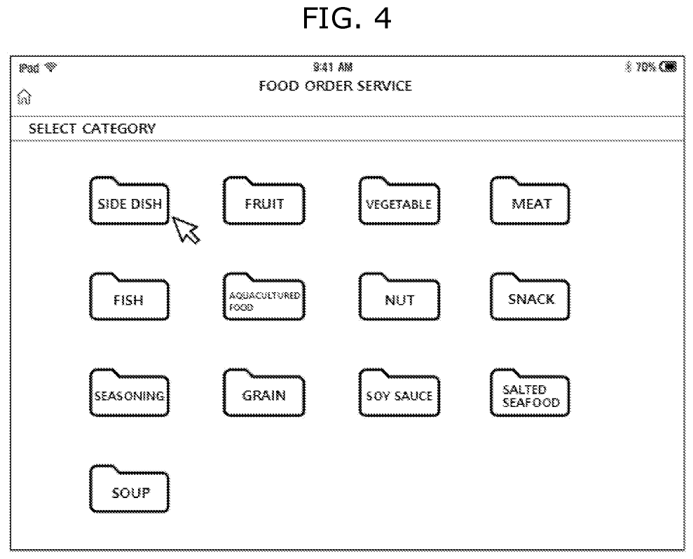

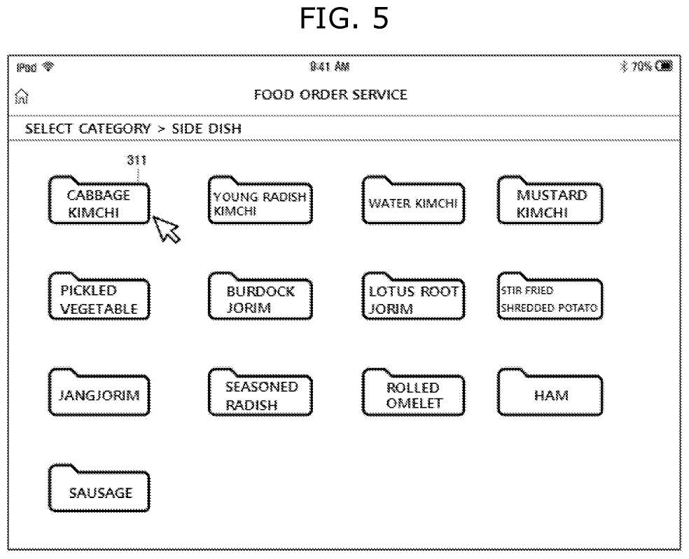

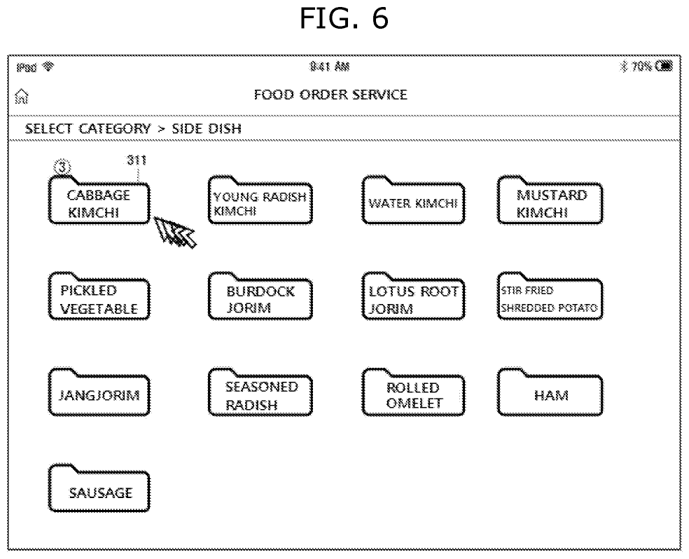

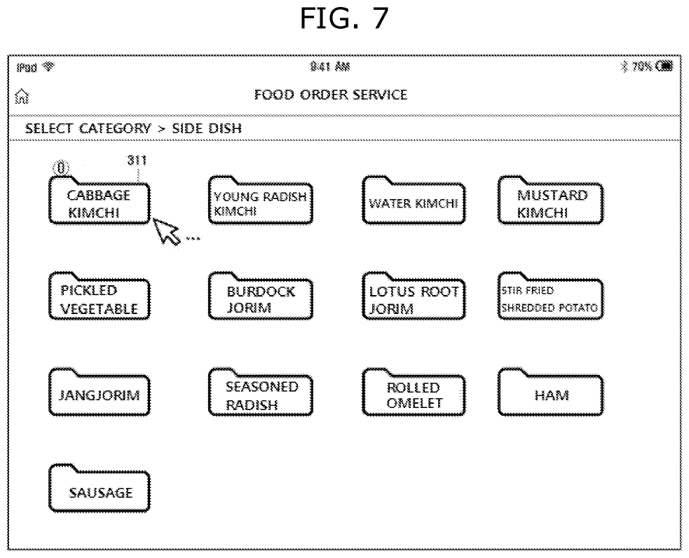

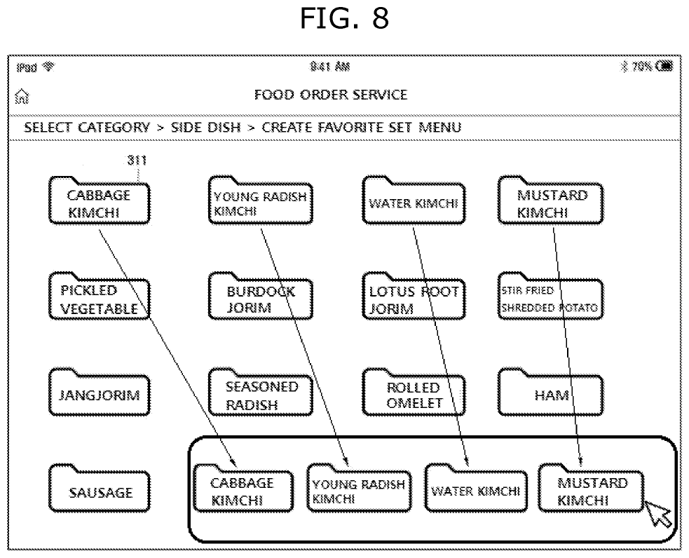

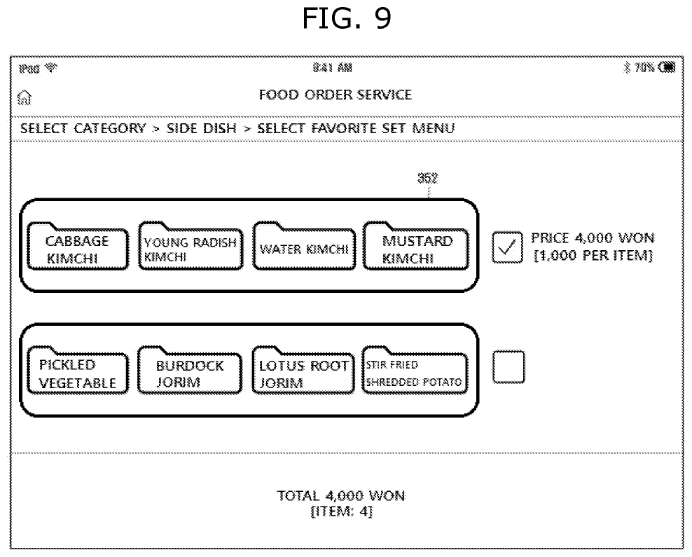

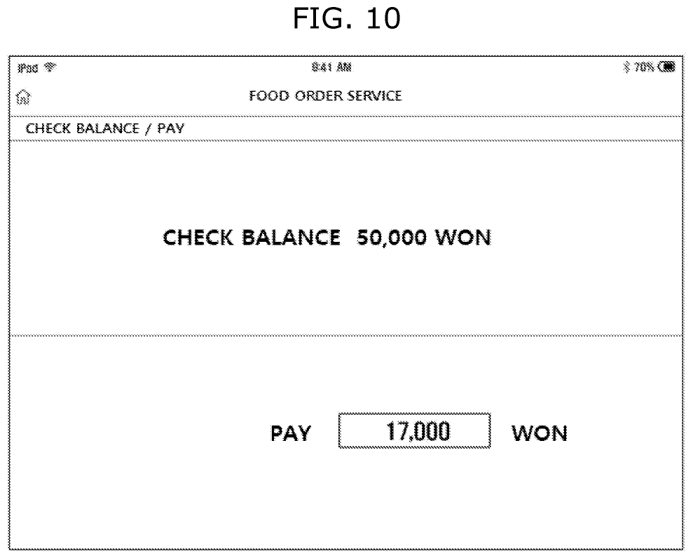

FIG. 1 is a schematic diagram illustrating an overall configuration relationship of a food order service system according to an embodiment of the present invention. FIG. 2 is a block diagram illustrating an overall configuration of a food order service system according to an embodiment of the present invention. FIG. 3 is a block diagram illustrating a detailed configuration of an orderer service execution unit according to an embodiment of the present invention. FIG. 4 is a drawing illustrating a food category selection screen of a food menu information display selection unit according to an embodiment of the present invention. FIG. 5 is a drawing illustrating a food menu selection screen of the food menu information display selection unit according to an embodiment of the present invention. FIGS. 6 and 7 are drawings for explaining a function of counting up and resetting the number of food menu purchases through the food menu information display selection unit in the food menu information display selection unit. FIG. 8 is a drawing illustrating a method of creating a favorite set menu through a favorite set menu setting unit according to an embodiment of the present invention. FIG. 9 is a drawing illustrating a method of creating a favorite set menu through a favorite set menu setting unit according to an embodiment of the present invention. FIGS. 10 to 12 are drawings for explaining a method of selecting and setting the number of menus within a budget price through a balance based food ordering unit according to an embodiment of the present invention.

FIGS. 1 and 2, the food order service system 1000 according to an embodiment of the present invention comprises an operation server unit 100, a seller service execution unit 200, and an orderer service execution unit 300.

The operation server unit 100 stores various types of food menu information and ingredient information for each of the corresponding food menu information, generates order information selected by the orderer based on the food menu information, transmits the order information to a seller, and processes payment for each order information.

The operation server unit 100 connects between a seller communication terminal 10 and an orderer communication terminal 20 through a network, provides update information received from a seller communication terminal 10 to an orderer communication terminal 20 to share, transmits order information requested from the orderer communication terminal 20 to the seller communication terminal 10, executes payment processing for the order information of the orderer communication terminal 20, may execute calculation of a remaining amount excluding a commission from a cost in the payment to transmit it the seller communication terminal 10, and may perform promotion or an advertising activity of a affiliated store represented by the seller communication terminal 20.

The operation server unit 100 is a database-based web server and may have the same configuration as a conventional web server in terms of hardware. In terms of software, the operation server unit 100 may be embodied through various types of languages such as C, C++, Java, Visual Basic, and Visual C and thus may include program modules that perform various functions. In addition, the operation server unit 100 may be embodied on general server hardware by using web server programs that are provided in different types according to operating systems such as DOS, Windows, Linux, Unix, and Macintosh.

The operation server unit 100 is connected to the seller communication terminal 10 and the orderer communication terminal 20 through a network, respectively. Examples of such networks may include RF, 3GPP (3rd Generation Partnership Project) network, LTE (Long Term Evolution) network, 5GPP (5th Generation Partnership Project) network, WIMAX (World Interoperability for Microwave Access) network, Internet, LAN (Local Area Network), Wireless LAN (Wireless Local Area Network), WAN (Wide Area Network), PAN (Personal Area Network), Bluetooth network, NFC (Near Field Communication) network, satellite broadcasting network, analog broadcasting network, DMB (Digital Multimedia Broadcasting) network but are not limited thereto.

The seller service execution unit 200 is installed in the seller communication terminal 10, registers and updates each food menu information and ingredient information in the operation server unit 100, and receives order information generated from the orderer communication terminal 20 from the operation server unit 100, and when the order information is received through the seller service execution unit 200, the food provided in the store is packaged and then delivered to the address included in the order information.

In this case, the food menu information registered and updated through the seller service execution unit 200 may include at least one food category of side dish, fruit, vegetable, meat, fish, aqua-cultured food, nut, snack, seasoning, grain, soy sauce, salted fish, and soup and may include various specific food menu information for each food category and ingredient information for the corresponding food menu.

The seller service execution unit 200 may be implemented in the form of a program or an application, and thus the seller communication terminal 10 may include a POS terminal or other communication terminal in a store. The other communication terminals may include a general PC as well as a portable communication device, such as PCS (Personal Communication System), GSM (Global System for Mobile communications), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), Wibro (Wireless Broadband Internet) terminal, smartphone, smart pad, and tablet PC.

The orderer service execution unit 300 is installed in the orderer communication terminal 20 and may receive food menu information and ingredient information from the operation server unit 100, classify the food menu information by category, provide the classified food menu information to the orderer so that they can select food, generate order information based on selected food menu information, and transmit to the operation server unit 100.

The orderer service execution unit 300 may include a food menu information display selection unit 310, a food ingredient information display unit 320, a payment request unit 330, an order request unit 340, a favorite set menu setting unit 350, a favorite set menu selection unit 360, a balance charge unit 370, and a balance based food ordering unit 380.

The food menu information display selection unit 310 may display the food menu information as food icons selectable by the orderer.

For example, as shown in FIG. 4, the food menu information display selection unit 310 may classify and display food menu information by each category, such as side dish, fruit, vegetable, meat, fish, aqua cultured food, nut, snack, seasoning, grain, soy sauce, salted seafood, and soup. When each category, for example, the side dish category, is selected, food icons 311 as shown in FIG. 5, such as cabbage kimchi, young radish kimchi, water kimchi, mustard kimchi, pickled vegetable including jangajji, burdock jorim, which is boiled down in soy sauce, lotus root jorim, which is boiled down in soy sauce, stir fried shredded potato, Jangjorim, seasoned radish, rolled omelet, ham, sausage, may be displayed. Each food icon 311 may be configured to be selectable by the orderer. In addition, such food icon 311 may be displayed as an image indicating what the corresponding food is, and when the cursor in the orderer communication terminal 20 is positioned at, selects, or touches around the corresponding icon 311, food ingredient information related to the corresponding icon 311 may be floated to be displayed. The food ingredient information that is floated to be displayed may disappear when another icon 311 is selected or when a food ingredient information selection for another icon 311 is input. The ingredient information may also include details on what ingredients are used to make the food menu indicated by the corresponding icon 311, what cooking method is used, and the like.

Whenever the food icon 311 is selected, the food menu information display selection unit 310 may count up the quantity of the selected food menu and displays the quantity of the food menu on the food icon 311. However, when a selection of the food icon has been kept over a preset period of time, the previously selected food may be reset.

For example, as shown in FIG. 6, when the cabbage kimchi icon 311 is selected, clicked, or touched three times consecutively, or discontinuously, information ‘\textcircled{3}’ is displayed on the corresponding icon 311. The information ‘\textcircled{3}’ indicates the quantity of the corresponding food menu. However, as shown in FIG. 7, when the selection of the corresponding icon 311 is kept over a certain period of time, the quantity of the corresponding food menu may reset and become ‘0’. This function may be available only in the case of a touch method. However, in the case of in a PC version, the quantity of the corresponding icon 311 may be reset by an operation command of dragging the corresponding icon 311 out of the screen.

The ingredient information display unit 320 may display ingredient information with respect to the food menu information selected through the food menu information display selection unit 310. In this case, the ingredient information is registered in advance. As described above, when the cursor in the orderer communication terminal 20 is positioned on a specific icon 311 or when a periphery of the icon 311 is selected or touched, food ingredient information related to the corresponding icon 311 may be floated to be displayed. The food ingredient information that is floated and displayed may disappear when another icon 311 is selected or when a selection for food ingredient information of another icon 311 is input. The ingredient information may also include details on what ingredients is used to make the food menu indicated by the corresponding icon 311, what cooking method is used, and the like.

The payment request unit 330 may calculate and display a total payment amount for the food menu information selected through the food menu information display selection unit 310 and may request payment for the corresponding payment amount to the operation server unit 100 according to the selection of the orderer. In this case, the system 1000 can be used after completing a membership registration process. The payment request unit 330 may proceed with the payment request based on information such as the order's name, contact information, address, communication terminal information, linked account, and linked card registered in the membership registration process.

When the operation server unit 100 completes the payment processing, the order request unit 340 may generates order information for the food menu information selected through the food menu information display selection unit 310 and transmit the order information to the operation server unit 100. The order request unit 340 may also generate order information including information such as the order's name, contact information, communication terminal information, address, linked account, linked card, and others registered at the membership registration process and transmit the order information to the operation server unit 100.

The favorite set menu setting unit 350 may generate a favorite set menu 352 by moving at least one of the food icons 311 provided through the food menu information display selection unit 310 to a favorite area 351.

For example, if a separate favorite area creation button is selected or a circle shaped drawing pattern is input on the screen, the favorite area 351 may be generated. Then, as shown in FIG. 8, when the food icon 311 is put into the favorite area 351 by a drag & drop method, and an operation is executed in such a way that a separate completion button is selected, or the favorite area is moved out of the screen, the favorite set menu 352 may be generated as shown in FIG. 9. In the favorite set menu 352, the orderer can generate a personal package of food that the orderer mainly eats or food that needs to be ordered periodically or regularly according to a specific purpose, thereby allowing the orderer to order conveniently without selecting one by one. The food menu included in the favorite set menu 352 may include food of different categories. For this type of the favorite set menu 352, when the orderer goes to the previous page in an activated state of the favorite area 351, the favorite area 351 is kept being floated, thereby allowing other food menus included in other categories to be included into the favorite area 351 in other pages including the previous page. The food menu included in the favorite set menu 352 may be changed, such as addition and deletion. When a separate change button is selected or the food menu is kept being selected for a predetermined period of time is selected, the food menu can be added or deleted as desired.

The favorite set menu selection unit 360 may receive a selection in a unit of the favorite set menu 352 and may transmit food menu information included in the selected favorite set menu 352 to the payment request unit 330.

For example, as shown in FIG. 9, at least one favorite set menu 352 previously registered by the orderer is displayed. When a desired favorite set menu 352 is checked according to the situation or need of the orderer, the total amount to be paid is displayed. In this case, information such as a unit price and quantity may also be displayed. In addition, when a payment and order request for the checked favorite set menu 352 is requested, the favorite set menu selection unit 360 requests the payment and order processing to the operation service unit 100 in conjunction with the payment request unit 330 and the order request unit 340.

The balance charge unit 370 may charge a certain amount of money in balance of the orderer in conjunction with the operation server unit 100 according to the selection of the orderer. In one embodiment of the present invention, a general payment method and a rechargeable payment method may be applied to the system 1000. The general payment method is a method of using account transfer, card payment, and others when paying for necessary food orders, and the rechargeable payment method is a method of deducting a certain amount as needed from a deposit or a balance. If the orderer uses the deposit, balance, or rechargeable payment method, the balance charge unit 370 provides balance information or charged amount information which is currently available to the orderer as shown in FIG. 10. In this case, the orderer may partially set a price limit to be used in order to order and pay for food only within that price limit.

The balance based food ordering unit 380 is input a payable amount within the deposit, balance, or charged amount through the balance charge unit 370, and when the payable amount is set, the balance based food ordering unit 380 generates a virtual menu block 381 with a size corresponding to the set payable amount, forms each food included in the food menu information selected through the food menu information display selection unit 310 into menu unit blocks M1 to M5, respectively, and includes them into the virtual menu block 381. The sizes of the menu unit blocks are adjusted according to the orderer's operation. However, the sum of the total sizes of the menu unit blocks M1 to M5 is adjusted not to exceed the size of the virtual menu block 381. Accordingly, the quantity of food menu representing each menu unit block with an adjusted size can be adjusted within the price limit.

For example, as shown in FIG. 10, when the price limit is set to 17,000 won, the order and payment can be made by selecting food menu within the set 17,000 won.

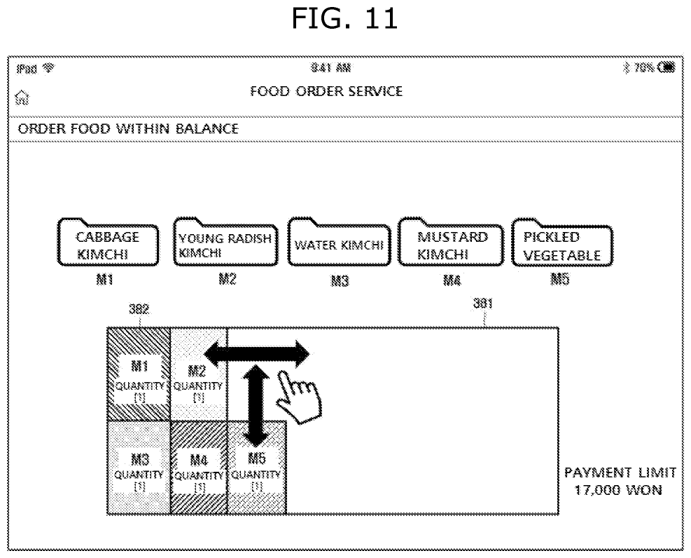

In addition, as shown in FIG. 11, when selecting to order a total of five side dishes including cabbage kimchi, young radish kimchi, water kimchi, mustard kimchi, and pickled vegetable, the virtual menu block 381 can be generated in order to select the quantity of the food menu within the price limit of 17,000 won. In the virtual menu block 381, menu unit blocks M1 to M5 representing each food menu selected by the orderer may be located with a basic unit size.

The menu unit blocks M1 to M5 located in the virtual menu block 381 can move up, down, left, and right like a puzzle along a predetermined line within the virtual menu block 381 according to manipulation of the orderer, and the sizes of the menu unit blocks M1 to M5 can also increase or decrease in a certain unit.

In this case, a minimum size limit of the menu unit block at which each size of the menu unit blocks M1 to M5 can be reduced to the smallest, is a size indicating one food unit, that is, one food menu. In addition, a maximum size limit of the menu unit block at which each size of the menu unit blocks M1 to M5, can increase to the largest, is a size obtained by subtracting the total sizes of minimum size limits of the other menu unit blocks included in the virtual menu block 381 from the total size of the virtual menu block 381.

That is, in the virtual menu block 381, the smallest size of each of the menu unit blocks M1 to M5 is a size of one food unit, and the largest size of an arbitrary menu unit block is a size obtained by subtracting the smallest sizes of other menu unit blocks from the total size of the virtual menu block 381.

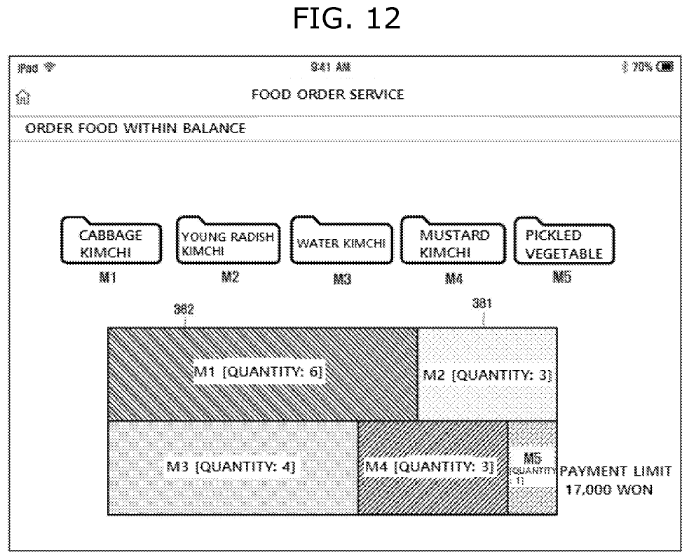

According to this configuration, as shown in FIG. 12, the orderer can adjust the quantity of food menus within the purchase setting limit of 17,000 won set by the orderer intuitively, conveniently and accurately without a separate calculation process, through operations of increasing or decreasing the size of the menu unit blocks M1 to M5 representing the food menu selected by the orderer between the maximum and minimum sizes.

According to this embodiment, various food can be purchased and delivered to customers at a low price, thereby improving a household economy, minimizing food waste generated in a process of cooking food, and contributing the public health by supplying food at a low cost and allowing people to consume a broad variety of food.

In addition, since all food and ingredients can be supplied from thousands won, this low price can be considerably helpful to the household or individual economy.

In the case of conventional food delivery systems, since complicated processes such as various costs including a restaurant space rent or purchase cost, an operating cost, and a labor cost and various process including cooking, advertisement, ordering, brokerage, delivery, and payment, occur, consumers have to bear expensive food costs. However, the present invention can reduce the food price by half by directly managing all the systems and thus can greatly help the household economy.

What is claimed is:

1. A food order service system comprising:
an operation server unit storing various types of food menu information and ingredient information for each of the food menu information, generating order information selected by an orderer based on the food menu information, transmitting the order information to a seller, and processing a payment for the order information;
a seller service execution unit installed in a seller communication terminal, registering the food menu information and the ingredient information in the operation server unit, and receiving the order information from the operation server unit; and
an orderer service execution unit installed in an orderer communication terminal, receiving the food menu information and the ingredient information from the operation server unit, classifying the food menu information by category, providing the classified food menu information to the orderer so that the orderer selects food menu in each category, generating the order information based on selected food menu information, and transmitting the order information to the operation server unit.

2. The food order service system of claim 1, wherein the food menu information includes food menu information with respect to at least one food category of side dish, fruit, vegetable, meat, fish, aqua cultured food, nut, snack, seasoning, grain, soy sauce, salted fish, and soup.

3. The food order service system of claim 1, wherein the orderer service execution unit comprises:
a food menu information display selection unit displaying the food menu information for each food menu as a food icon selectable by the orderer;
a food ingredient information display unit displaying ingredient information with respect to the food menu information selected through the food menu information display selection unit;
a payment request unit calculating and displaying a payment amount for the food menu information selected through the food menu information display selection unit and requesting a payment for the corresponding payment amount to the operation server unit according to a selection of the orderer; and
an order request unit generating order information for the food menu information selected through the food menu information display selection unit when the operation server unit completes the payment and transmitting the order information to the operation server unit.

4. The food order service system of claim 3, wherein whenever the food icon is selected, the food menu information display selection unit counts up a quantity of the selected food menu and displays the quantity of the food menu on the food icon, and when a selection of the food icon has been kept over a preset period of time, the previously selected food menu is reset.

5. The food order service system of claim 3, wherein the orderer service execution unit comprises:
a favorite set menu setting unit generating a favorite set menu by moving at least one of the food icon provided through the food menu information display selection unit to a favorite area; and
a favorite set menu selection unit receiving a selection in a unit of the favorite set menu and transmitting the food menu information included in the selected favorite set menu to a payment request unit.

6. The food order service system of claim 1, wherein the food order service system is operated by being applied in an offline store and an online store connected to the seller communication terminal and receiving an order from the orderer communication terminal.
